(19) United States
(12) Patent Application Publication
(10) Pub. No.: US 2020/0377255 A1
(43) Pub. Date: Dec. 3, 2020

(54) A PACKAGING MATERIAL, AND A METHOD FOR PROVIDING SUCH PACKAGING MATERIAL

(71) Applicant: Tetra Laval Holdings & Finance S.A., Pully (CH)

(72) Inventors: Linda Luik, Malmö (SE); Andreas Larsson, Dalby (SE); Per Wänersjö, Lund (SE)

(21) Appl. No.: 16/604,765

(22) PCT Filed: Apr. 9, 2018
(86) PCT No.: PCT/EP2018/059023

§ 371 Date: Oct. 11, 2019

(30) Foreign Application Priority Data
Apr. 12, 2017 (EP) 17166280.2

(51) Int. Cl. B65D 5/42; B31B 50/25; B65D 5/06

(52) U.S. Cl. CPC B65D 5/4266; B31B 50/25; B31B 2110/30; B65D 5/067; B65D 5/065

(57) ABSTRACT

A packaging material is provided, comprising a set of crease lines (10, 10′) along which the packaging material is intended to be folded in order to form a package. The set of crease lines (10, 10′) comprises at least one first crease line (10a, 10′a) being configured to fold easier than an adjacent second crease line (10b, 10′b). The said crease lines are intended to define a corner surface of the package.

### CROSS-REFERENCE TO RELATED APPLICATIONS

This application is the U.S. National Phase under 35 U.S.C. § 371 of International Application PCT/EP2018/059023, filed Apr. 9, 2018, which claims priority to EP Application No. 17166280.2, filed Apr. 12, 2017, the entire contents of each of which are incorporated by reference herein and made a part of this specification.

### TECHNICAL FIELD

The present solution relates to a packaging material, especially for packaging material intended to form individual packages for e.g. liquid food. It also relates to a method for providing such packaging material, as well as to a method for forming individual packages from such packaging material.

### BACKGROUND ART

Individual packages, e.g. packages used to enclose limited quantities of liquid food, are typically formed from a packaging material. The packaging material comprises a carton-based material layer, such as paper board or card board, having inner and outer layers of polymer which are laminated together in a lamination apparatus.

For producing individual packages the packaging material is fed to a filling machine either on a roll of packaging material or as individual packaging material blanks. A filling machine which could be either roll-fed or blank-fed includes various stations for transforming the packaging material fed into it into filled and sealed three-dimensional packages.

The forming process, i.e. the method of transforming the packaging material to a three-dimensional object, is facilitated by providing the packaging material with crease lines. As the packaging material will fold at the positions of the crease lines it is possible to configure the packaging material beforehand according to various different shapes. Such shapes include e.g. Tetra Rex®, Tetra Brik®, and Tetra Prisma®. If a packaging material is intended to be transformed into a Tetra Rex® package, a web of packaging material is cut into individual blanks and a specific crease line pattern, corresponding to the final shape, is provided onto the packaging material before the packaging material blanks enter the filling machine.

As the desire for complex package forms is increasing more advanced crease line patterns are required. When the distance between two adjacent crease lines on the packaging material is decreased, e.g. in order to form an angled corner of a package, the forming process will be more difficult to control. There is particularly a risk that one fold is effected along one certain crease line, which fold prevents folding of the packaging material along an adjacent crease line. This is due to the fact that forming (i.e. folding of the packaging material along the crease line) is performed in a specific sequence defined by the forming tools of the filling machine. Should one fold occur along an unintended crease line the final package will have a shape not corresponding to the desired shape.

In view of the above problem there is a need for an improved packaging material which reduces the risk for misforming of the package.

### SUMMARY

It is an object of the present solution to at least partly overcome one or more of the above-identified limitations of the prior art. In particular, it is an object to provide a solution which allows the packaging material to fold correctly, even if the crease lines are arranged very close to each other. To solve these objects a packaging material is provided. The packaging material comprises a set of crease lines along which the packaging material is intended to be folded in order to form a package, wherein the set of crease lines comprises at least one first crease line being configured to fold easier than an adjacent second crease line where the first and second crease lines are intended to define a corner surface of the package and where that corner surface extends along the vertical direction of the package to be formed.

The set of crease lines may be formed by compressing the packaging material.

The first crease line may be compressed to a greater extent than the adjacent second crease line, and/or the width of the first crease line may be greater than the width of the second crease line.

The first and second crease lines may be intended to define a corner surface of the package.

The width of the first crease line is greater than the width of the second crease line.

The packaging material may be in the form of a blank intended to form an individual package, or in the form of a web intended to form a series of individual packages.

The distance between the first and second crease lines may be 30 mm or less.

According to a second aspect, a method for producing a packaging material is provided. The method comprises providing a set of crease lines along which the packaging material is intended to be folded in order to form a package, by providing at least one first crease line and providing an adjacent second crease line, wherein the first crease line is configured to fold easier than the adjacent second crease line and where the first and second crease lines are intended to define a corner surface of the package. Here the corner surface extends along the vertical direction of the package to be formed.

The first and second crease lines may be provided simultaneously.
The set of crease lines may be provided by compressing the packaging material.
The width and/or depth of the first crease line may be greater than the width and/or depth of the second crease line.
According to a third aspect, a method for producing a package is provided. The method comprises providing a packaging material by performing the method according to the second aspect, and folding, filling, and sealing the packaging material.
The first and second crease lines of the packaging material may be folded in a single folding operation.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is an isometric view of a package produced by a packaging material according to an example;

FIG. 2 is an isometric view of a package produced by a packaging material according to an example;

FIG. 3a is a view of packaging material blank for producing a package similar to the package shown in FIG. 1a;

FIG. 3b is an isometric view of the packaging material shown in FIG. 3a during raising of the package;

FIG. 4 is a view of a packaging material blank for producing a package similar to the package shown in FIG. 2;

FIG. 5a is a cross-sectional view of a packaging material according to an example;

FIG. 5b is a cross-sectional view of a packaging material according to a second example;

FIG. 6 is cross-sectional view of a packaging material according to an embodiment; and

FIG. 7 is a schematic view of a method according to an embodiment.

### DETAILED DESCRIPTION

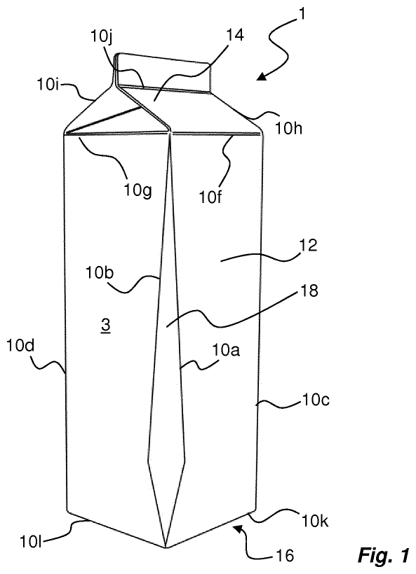

With reference to FIG. 1 an example package 1 is illustrated. The package 1 is formed into the three-dimensional shape from a packaging material 3. Shaping of the packaging material 3 is performed by folding the packaging material along a set 10 of pre-arranged crease lines 10a-l. It should be understood that not all crease lines are provided with reference numerals; additional crease lines (not shown) are provided on the package material 3 for complete folding and forming of the package 1. As indicated in FIG. 1 the crease lines 10a-d are provided in order to define a longitudinal body 12 of the package 1, the crease lines 10f-j are provided in order to define the upper gable-top end 14 of the package 1, and the crease lines 10k-l are provided in order to define the bottom end 16 of the package 1.

The crease line 10a forms a first crease line being arranged adjacent to a second crease line 10b. The first and second crease lines 10a-b together define an corner surface 18 of the package 1, wherein the corner surface 18 extends at an angle relative its adjacent panels (i.e. one panel extending between crease lines 10a and 10d, and one panel extending between crease lines 10b and 10c). The corner surface 18 is not only provided to improve the aesthetic appearance of the package 1, but also to improve gripping of the package 1.

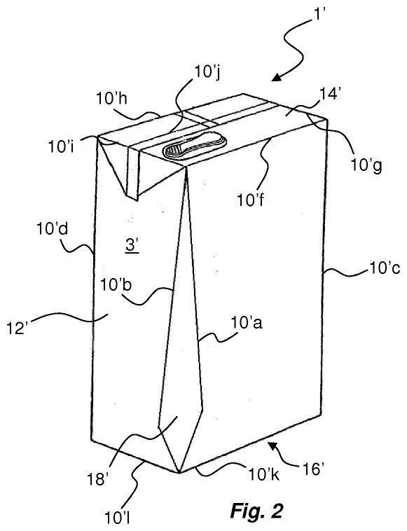

With reference to FIG. 2 another example of a package 1′ is illustrated. As for the package 1 shown in FIG. 1 the package 1′ is formed into the three-dimensional shape from a planar packaging material 3′ by folding the packaging material 3′ along a set 10′ of pre-arranged crease lines 10′a-l. As indicated in FIG. 2 the crease lines 10′a-d are provided in order to define a longitudinal body 12′ of the package 1′, the crease lines 10′f-j are provided in order to define the upper end 14′ of the package 1′, and the crease lines 10′k-l are provided in order to define the bottom end 16′ of the package 1′. It should be understood that additional crease lines (not shown) are provided on the package material for complete folding and forming of the package 1′.

The crease line 10′a forms a first crease line being arranged adjacent to a second crease line 10′b. The first and second crease lines 10′a-b together define a corner surface 18′ of the package 1′.

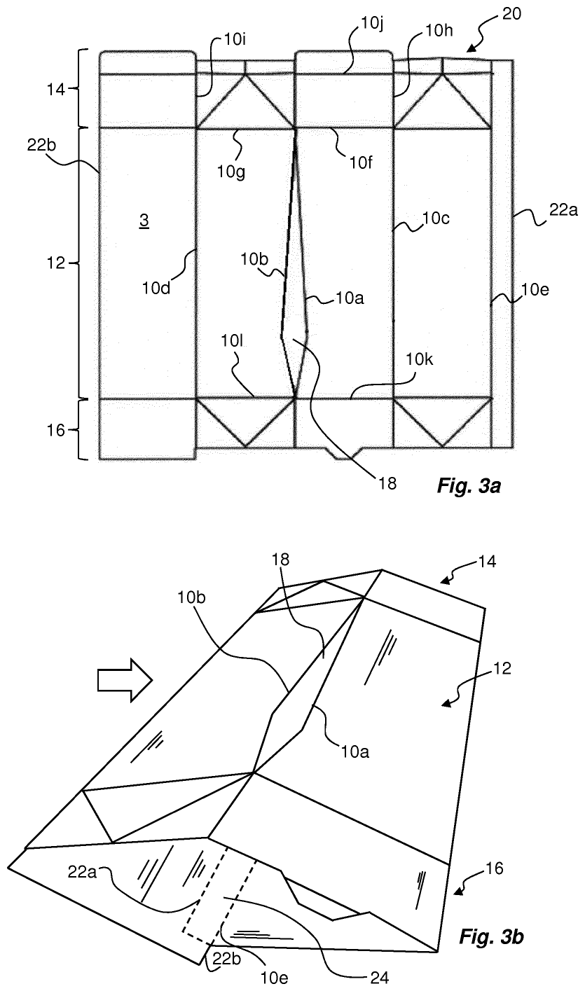

A package similar to the package 1 shown in FIG. 1 is preferably produced from a blank 20 of packaging material 3 shown in FIG. 3a. The blank 20 is pre-cut so that the dimensions of the blank 20 will result in a package of desired size and shape. During forming the lateral ends 22a-b are sealed to each other in order to form a so-called half folded blank Such a half-folded blank is usually produced at a site different from the site of a filling machine where the final raising of the of the half-folded blank is effected. When being loaded into a filling machine the blank 20 is also folded along the crease lines 10c-d for forming an open ended main body 12 of the package. In a following step the corners of the main body 12 are formed by folding the main body along crease line 10e, as well as along crease lines 10a-b. Subsequently one of the upper or lower ends 14, 16 are formed and sealed whereafter filling and final sealing of the still open end is performed.

In another variant, a web of paperboard material comprising the blanks corresponding to the blank in FIG. 3a is loaded into a filling machine where the blanks are cut into individual blanks 3a and where the panels 22a and 22b are sealed to form a tube. Thereafter the blank 20 is raised into a container in the same fashion as described in the previous paragraph.

When folding the crease lines 10a-e a rectangular body 12 will be formed, however having one corner defined by the angled corner surface 18 arranged between the first crease line 10a and the second crease line 10b.

When defining the corners of the rectangular main body, during folding of the crease lines 10a-b, 10e the packaging material 3 will be subject to a force requiring the packaging material 3 to move in a desired direction. This means that for folding the main body 12 (and/or the upper or bottom end 14, 16) a single operation is performed whereby the crease lines 10a-b, 10e will allow for simultaneous folding. This is shown in FIG. 3b. Here the lateral ends 22a-b have been sealed to provide for a longitudinal sealing 24, and folding is performed along the crease lines 10a-b, 10e to provide the rectangular main body 12. Raising of the package 1 may e.g. be done by applying a folding force to at least one of the pre-folded edges, extending along the crease lines 10c-d, as indicated by the block arrow. During this folding sequence it is important that the first crease line 10a will begin to fold before the second crease line 10b begins to fold. Should the opposite occur, i.e. that the second crease line 10b begins to fold prior to the first crease line 10a, there is a risk that the semi-raised package 1 will be locked in position, preventing the first crease line 10a to fold. The resulting package 1 will thus not correspond to the desired shape. On the other hand, as the raising force comes from the left when the first crease line 10a begins folding the second crease line 10b will fold automatically.

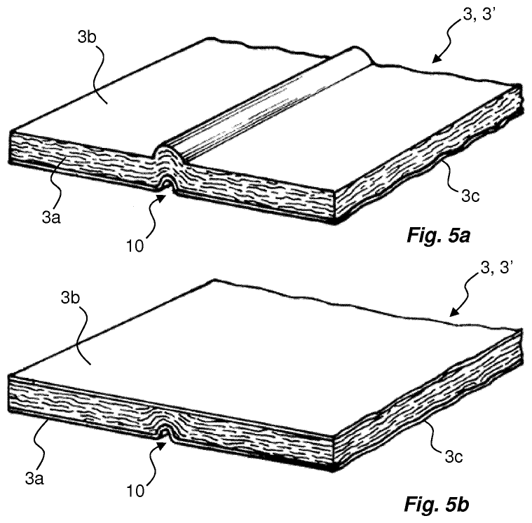

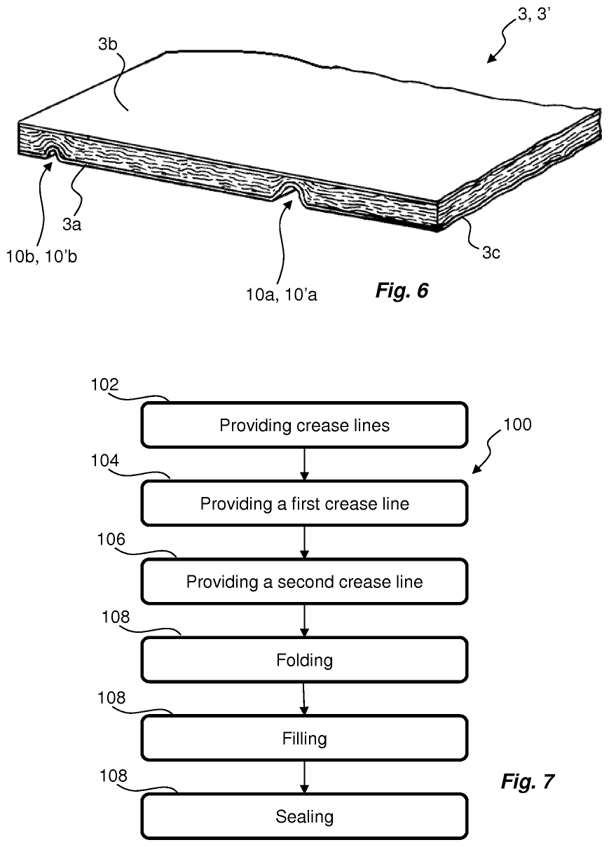

Hence the packaging material 3 is configured to allow for controlled folding as will be further described with reference to FIGS. 5-6.

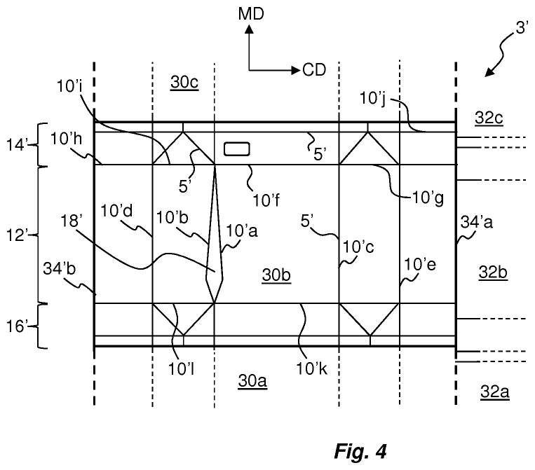

A package similar to the package 1′ shown in FIG. 2 is preferably produced from a web 30 of packaging material 3′ shown in FIG. 4. The web 30 is dimensioned so as to accommodate several consecutive segments 30a-c, 32a-c. Each segment 30a-c, 32a-c is designed to provide a single package 1′. Segments 30a-c are longitudinally aligned while the segments 32a-c are also longitudinally aligned in the machine direction MD. However the segments 30a-c are staggered relative segments 32a-c in the cross-direction CD. Before forming and filling segments 32a-c are cut from segments 30a-c such that the web 30 entering the filling machine has only one row of segments 30a-c. Each segment 30a-c, 32a-c is configured such that the dimensions of one segment 30a-c, 32a-c will result in a package 1′ of desired size and shape. During forming the lateral ends 34′a-b are sealed to each other so that a tube is formed. As the tube is filled with content the tube is also folded along the crease lines 10′a-e for forming an open ended main body 12′ of the package. Simultaneously the ends 14′, 16′ are formed and sealed, and the final package 1′ is separated from the upstream tube.

When folding the crease lines 10′a-e a rectangular body 12′ will be formed, however having one corner defined by the angled corner surface 18′ arranged between the first crease line 10′a and the second crease line 10′b. The folding sequence is typically subject to the same concerns as described with reference to FIG. 3b, i.e. it is important to allow for initial folding of the first crease line 10′a before folding of the second crease line 10′b is initiated.

Although the corner surfaces 18, 18′ are shown having a similar shape it should be noted that first and second crease lines 10a-b, 10′a-b could be configured in a wide range of alternatives, e.g. as indicated by FIGS. 1b-h. For example, the first and second crease lines 10a-b, 10′a-b could be curved, or they may not extend along the entire length of the main body 12, 12′. Even further the angled corned surfaces 18, 18′ could be provided at any corner of the package 1, 1′, e.g. they could replace one of the horizontal crease lines 10f, j, k, 10′e, f, j, k, l.

Controlled folding is preferably effected for two adjacent crease lines 10a-b, 10′a-b. The first and second crease line 10a-b, 10′a-b may typically, but not necessarily, form a corner surface 18, 18′ of the package 1, 1′. Hence the distance between the first and second crease line 10a-b, 10′a-b may be in the range of 5-30 mm, even more preferably between 10-20 mm.

Now turning to FIGS. 5a-b some structural details of the crease lines 10a-d, 10′a-d will be discussed. FIG. 5a shows a first example of packaging material 3, 3′ having a core layer 3a of a carton-based material. The inner side of the core layer 3a, i.e. the side intended to face the product enclosed by the final package 1, 1′, is covered with one or more layers 3b. The inside layers 3b may e.g. include an innermost layer, applied onto an aluminium foil. The innermost, inside layer may be composed of one or several part layers, comprising heat sealable thermoplastic polymers, such as adhesive polymers and/or polyolefins.

Also on the outside of the carton-based material layer 3a there is an outermost heat sealable polymer layer 3c.

In FIG. 5a a crease line 10 is formed in the packaging material 3, 3′ by embossing from the outside. This means that the outside will be compressed inwards, leading to an embossed feature on the inside of the packaging material 3, 3′. The local compression of the packaging material 3, 3′ will induce a weakness extending along the entire crease line 10 for facilitating folding of the packaging material 3, 3′.

In FIG. 5b the crease line 10 is compressed only, i.e. no embossed feature is present on the inside of the packaging material 3, 3′. This kind of crease line 10 may be realized by pressing the outside inwards while having a planar anvil on the inside of the packaging material 3, 3′.

For allowing folding control of the packaging material 3, 3′ all crease lines 10a-l, 10′a-l are not identically dimensioned. As can be seen in FIG. 6 a part of a packaging material 3, 3′ is shown in which two adjacent crease lines 10a-b, 10′a-b are dimensioned differently such that the first crease line 10a, 10′a is configured to fold easier than the second crease line 10b, 10′b.

The first crease line 10a, 10′a is in the shown example not only compressed to a greater extent, but its width is also greater than the width of the second crease line 10b, 10′b. It should be noted that it is not required to have both increased depth and increased width, but each one of these features by its own will reduce the robustness of the packaging material 3, 3′ compared to the second crease line 10b, 10′b. Further to the shown example, the entire length of the first crease line 10a, 10′a may not be homogenously formed, but only parts of the first crease line 10a, 10′a may be dimensioned different from the second crease line 10b, 10′b still resulting in the first crease line 10a, 10′b being easier to fold than the second crease line 10b, 10′b.

In FIG. 7 a method 100 for producing a packaging material 3, 3′, as well as producing a package 1, 1′ from such packaging material 1, 1′ is shown. The method 100 comprises providing 102 a set of crease lines 10, 10′ along which the packaging material is intended to be folded in order to form a package, by i) providing 104 at least one first crease line 10a, 10′a and ii) providing 106 an adjacent second crease line 10b, 10′b, wherein the first crease line 10a, 10′a is configured to fold easier than the adjacent second crease line 10b, 10′b.

The first and second crease lines 10a-b, 10′a-b are provided simultaneously, for example by feeding the packaging material 3, 3′ through a nip formed between a creasing roller and an anvil roller. The set of crease lines 10, 10′ may be provided by compressing the packaging material 3, 3′ locally.

The method 100 may further comprise folding 108, filling 110, and sealing 112 the packaging material to form an individual package 1, 1′.

The first and second crease lines 10a-b, 10′a-b of the packaging material 3, 3′ are preferably folded in a single folding operation performed at the filling machine.

From the description above follows that, although various embodiments of the invention have been described and shown, the invention is not restricted thereto, but may also be embodied in other ways within the scope of the subject-matter defined in the following claims.

1. A packaging material comprising a set of crease lines along which the packaging material is intended to be folded in order to form a package, wherein the set of crease lines comprises at least one first crease line being configured to fold easier than an adjacent second crease line, wherein the first and second crease lines are intended to define a corner surface of the package and wherein the corner surface extends along the vertical direction of the package to be formed.

2. The packaging material according to claim 1, wherein the set of crease lines is formed by compressing the packaging material.

3. The packaging material according to claim 2, wherein the first crease line is compressed to a greater extent than the adjacent second crease line.

4. The packaging material according to claim 2, wherein the width of the first crease line is greater than the width of the second crease line.

5. The packaging material according to claim 1, wherein the packaging material is in the form of a blank intended to form an individual package.

6. The packaging material according to claim 1, wherein the packaging material is in the form of a web intended to form a series of individual packages.

7. The packaging material according to claim 1, wherein the distance between the first and second crease lines is 30 mm or less.

8. A method for producing a packaging material, comprising providing a set of crease lines along which the packaging material is intended to be folded in order to form a package, by
providing at least one first crease line, and
providing an adjacent second crease line, wherein the first crease line is configured to fold easier than the adjacent second crease line, wherein the first and second crease lines are intended to define a corner surface of the package and wherein the corner surface extends along the vertical direction of the package to be formed.

9. The method according to claim 8, wherein the first and second crease lines are provided simultaneously.

10. The method according to claim 8, wherein the set of crease lines is provided by compressing the packaging material.

11. The method according to claim 10, wherein the width and/or depth of the first crease line is greater than the width and/or depth of the second crease line.

12. A method for producing a package, comprising providing a packaging material by performing the method according to claim 10, and folding, filling, and sealing the packaging material.

13. The method according to claim 12, wherein the first and second crease lines of the packaging material are folded in a single folding operation.
